(19) United States
(12) Patent Application Publication
(10) Pub. No.: US 2012/0246231 A1
(43) Pub. Date: Sep. 27, 2012

(54) SYSTEM AND METHOD FOR MATCHING BY RECIPROCITY USING HIDDEN SELECTIONS

(76) Inventor: Sebastian Norena, Medelin (CO)

(21) Appl. No.: 13/349,075

(22) Filed: Jan. 12, 2012

Related U.S. Application Data
(60) Provisional application No. 61/466,394, filed on Mar. 22, 2011.

(51) Int. Cl. G06F 15/16

(52) U.S. Cl. 709/204

(57) ABSTRACT

The system and method described herein enables people to meet other people faster, easier, and less expensive than any other system and method available by a simple two way matching method that creates matches only when two users want to meet each other, and eliminates the fear of rejection.

In accordance with one embodiment of the system and method being described herein, users can choose other users they would like to meet but nobody will know who chooses who, unless two users choose each other (when two users choose each other, a match occurs), then the system sends a text message to both users notifying that they both want to meet each other including each other's contact information so they can communicate using a communication device like a cell phone, or meet in person immediately.

### CROSS-REFERENCE TO RELATED APPLICATIONS

This application claims the benefit of Provisional Patent Application Ser. No. 61/466,394, filed 2011 Mar. 22 by the present inventor.

### FEDERALLY SPONSORED RESEARCH

Not Applicable

### SEQUENCE LISTING OR PROGRAM

Not Applicable

### FIELD OF THE INVENTION

The present invention relates in general to a method that enables persons to meet other persons in a way that is easier and more comfortable than any other method known and, more particularly, to a system and method of matching that don't require users to reject other users and still lets people meet other people more effectively and more efficiently than any other method known.

### BACKGROUND AND SUMMARY

For centuries, humans have always needed to meet many other humans, the process of meeting new persons usually repeat several times in people's lifetime. As social creatures humans always need to meet new people for any reason or motivation, be it to make business, to make friends, to find a girlfriend or boyfriend, etc. Sometimes large groups of people get united by a common motivation and create social networks, for instance people who share faith motivations create religions, people who share business motivations create business networks, and people who share charity motivations create charity organizations or charity networks.

Initially social networks existed without the use of technology, but in recent years with the invention and advances on the internet, computers, digital devices and telecommunications, it has become possible to improve the way social networks get created and maintained, making social networks easier to create and to be formed faster and grow bigger than ever before. At the same time today's fast-paced lifestyles make necessary for people to use their time more efficiently in every aspect, including meeting other people in a more efficient and effective way, that is why online dating became so popular and is being used every time more than traditional ways to meet people.

Unfortunately online dating websites and applications that exist now days still have many problems and inefficiencies, most of them, first require a person to become a subscriber by completing a detailed profile, providing various details about him/her such as age, geographic location, physical characteristics, and likes and dislikes, the number of details often required is too long, it can be up to 100 details or more making the process too complicated and requiring the users to spend a lot of time just to create the profile, often making the users to leave the online dating service. After completing the profile, the user then can search for other users by entering similar criteria, such as age range, geographic location, and desired physical characteristics, which are subjective because someone may put on his/her profile that he/she has an “athletic type” body, but from the eyes of the person who is doing a search by “athletic type” body, it may not be an athletic body. So by now a lot of time has been invested by users of the existent online dating websites and applications, and the searches they make are subjective and completely dependent on the details each user considered to provide on his/her profile.

After searching, the individual can review the matching users' profiles, which may, or may not, contain a photograph. The individual then decides which of the matching users they would like to pursue, and sends them an e-mail in the hope of receiving a response. Users then get to know one another by exchanging e-mails in a very long process in which users never meet in person or do so after a long time (weeks or months), sometimes users have the option to communicate by chat using an instant messaging system or make video calls, but in all cases users take considerable time before meeting in person as there is always a cell phone, a computer or any other device between them, and they usually are not located as near as to meet in person immediately.

Some online dating websites and applications attempt to match users by an algorithm that compares attributes of their profiles, such as age, geographic location, height, and various likes and dislikes. They assign weightings to each matching factor, and then compute an overall score representing the degree of matching. One problem with this method of matching is that the weights assigned to each matching factor are arbitrary. For some individuals, it would be more important that their match was tall than if they had dark hair, but this is not taken into account. Fundamentally, this purely scientific approach to matchmaking does not work in practice. It is well known that if two individuals appear to be a good match based on attributes, it does not warranty there would be “chemistry” between them when they meet in person.

The present invention being described in this document offers great advantages over previous computer and non-computer matching systems because it provides a system and method that works faster, as the only data required for a user to create a profile is a cellular phone number, picture, e-mail, and password. Also users have the option to create a profile using the data they already entered in another social network account like Facebook, Twitter or any other similar social network where users create a profile with basic personal information, in that case users just would have to enter the user name and password of the other social network and authorize the data (picture, cell phone number, e-mail) to be downloaded from that account into the system being described herein.

After creating a profile that requires a very short time (two minutes or less), users will be able to search for other users who are near (at the same mall, bar, restaurant, stadium, school, building, hotel, etc . . . ) and choose all the users they would like to meet and wait for a match that can occur immediately or in a very short time (seconds, minutes, or hours), then the users that match will have each other's contact information so they can call, text-message, or meet each other in person immediately. The only thing a user has to do after creating a profile is choosing other users he/she would like to meet and wait for matches.

Also the system and method described herein doesn't require users to reject other users then no user is explicitly rejected, encouraging everyone to use it, as the main reason for people not trying other system and methods to meet people is the fear of rejection.

Then the system and method being described herein is easier to use, less expensive, takes less time for two users to meet in person than any other system and method, ensures people will meet in person almost immediately and completely eliminates rejection.

### BRIEF DESCRIPTION OF DRAWINGS

FIG. 1 shows a flow chart of an embodiment of the system and method herein.

FIG. 2 shows a network based embodiment of the method and system herein.

FIG. 3 shows the user interface that appears to a registered user when he/she wants to browse profiles of other users.

FIG. 4 shows the user interface that appears to a registered user when he/she wants to list the profiles of the users he/she wants to meet, that is, the users for which User1 has clicked on the “I want to meet this person” button 302 on the “Browse profiles” tab. When the system finds a match between 2 users it also shows contact data of the user with which there is a match 402.

FIG. 5 shows a flow chart of an embodiment of the system and method herein.

### DETAILED DESCRIPTION

### FIRST EMBODIMENT

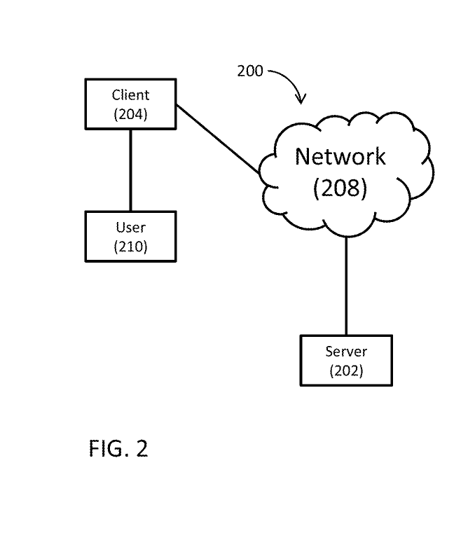

Referring first to FIG. 2, the basic components of the present embodiment of the invention are a server 202, a client 204 a user 210, and a network 208. The server 202 may refer broadly to any computer programmed and configured so the system and method works as described herein. A user 210 may refer broadly to anyone who uses the system and method described herein. A client 204 may refer broadly to any hardware or software that interacts with users 210 and servers 202 so the system and method works as described herein. Network 208 may refer broadly to any means of communication that could be used for data transfer between clients 204 and servers 202. The server interacts or communicates with the clients using a network 208. The embodiment of the system described herein works with at least one client 204, one server 202 and two users 210, but it will be readily understood for those skilled in the art, that the number of servers 202, clients 204, and users 210 can increase without altering the normal operation or the essence of the invention disclosed herein. It also will be readily understood by those skilled in the art, that a client 204 can be a computer (which could be anywhere) capable of interacting with users 210 and servers 202, an application installed on any device capable of interacting with users 210 and servers 202, a web browser capable of interacting with users 210 and servers 202, or any other hardware or software capable of interacting with users 210 and servers 202. Users 210 interact with the system through a client 204.

### Operation

### FIRST EMBODIMENT

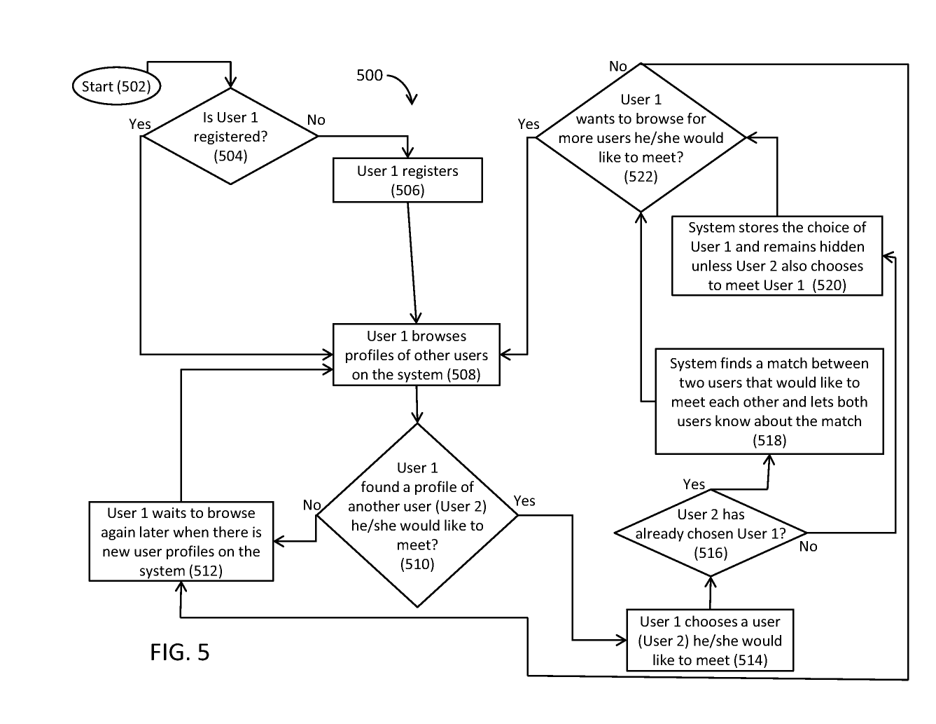

FIG. 5 is a high level block diagram describing one embodiment of the system and method disclosed herein. For explanation purposes the invention will be described as it is embodied in a system that facilitates humans (users) to meet other humans (users). It will be readily understood by those skilled in the art that the system and method disclosed herein is not so limited, as it can be used for many other different purposes, and can be made using many other different devices, software, networks, hardware, or means of communication.

FIG. 5 shows an embodiment in which a user 210 interacts with the system and method embodied herein (also referred to below as “the system”) for the first time, so it goes through all the steps from the start 502. If User1 hasn't registered 504 yet on the system he/she will be presented a screen where he/she can enter 506 his/her basic contact information in order to create a user profile, so User1 can be found later by other users in the system and can also be contacted when the system finds a match between User1 and other user, as explained in subsequent steps of the present embodiment. An e-mail, password, cell phone number and picture of the user are the only required fields for a user who wants to create a profile on the system. If the user has an account on a social network like Facebook, he/she can enter his/her Facebook's login information so his profile picture, name, gender and cell phone number are automatically downloaded to the users profile in the system, it will be readily understood for those skilled in the art that many other social networking services can be used for the same purpose other than Facebook.

Users also have the option to manually enter or modify the data on their profile. In order to upload his/her picture, a user can use a camera that is on the client he/she is using, or can use a picture from a website by saving the picture's link on the system. There are also 2 more fields that appear to the user on the profile creation screen which are not required, those are the name of the user and the gender of the user. After User1 enters the data in at least the required fields on the system, the data will be stored on the system database so it can be used later as explained in subsequent steps of the embodiment of the system and method being described herein.

Once User1 has entered and saved 506 his/her profile on the system, other users will be able to see User1's profile including only User1's picture, name and gender (if User1 decided to include his/her name and gender as for this embodiment of the system and method they are optional). The cell phone number of User1 (or any other user) will not be displayed on the system yet; it will be displayed or sent only when there is a match between 2 users as explained in subsequent steps of the embodiment of the system and method being described herein. User1 makes a decision about who he/she would like to meet, this decision is personal and may have been made just by seeing someone at a public or non public place, online or offline, by seeing his/her profile information on the system embodied herein, or by any other reason User1 may want to meet another user of the system embodied herein.

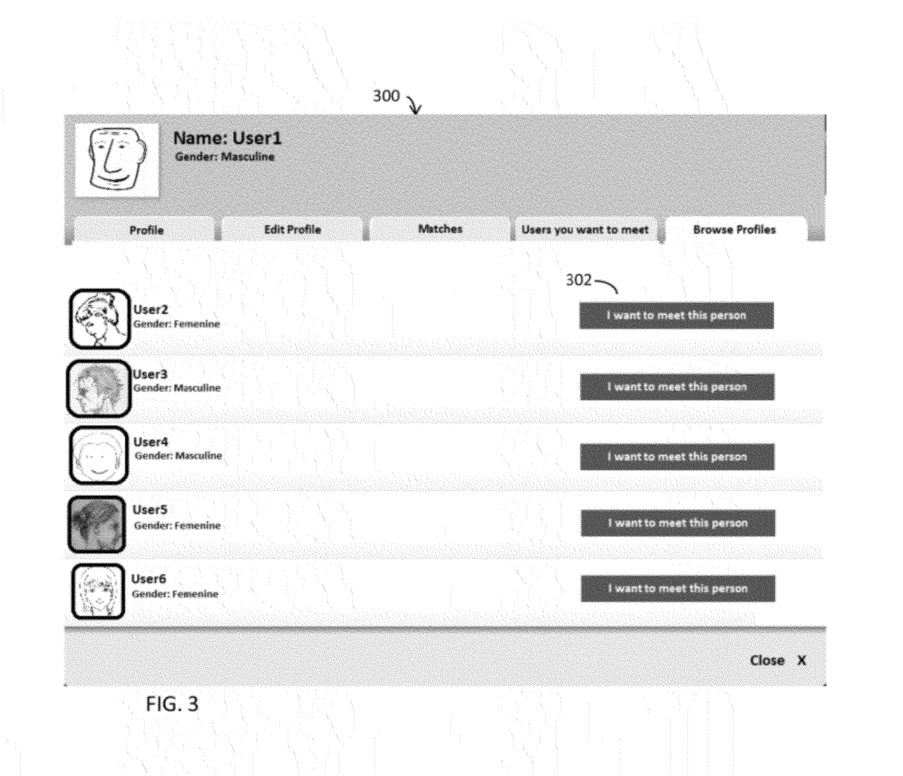

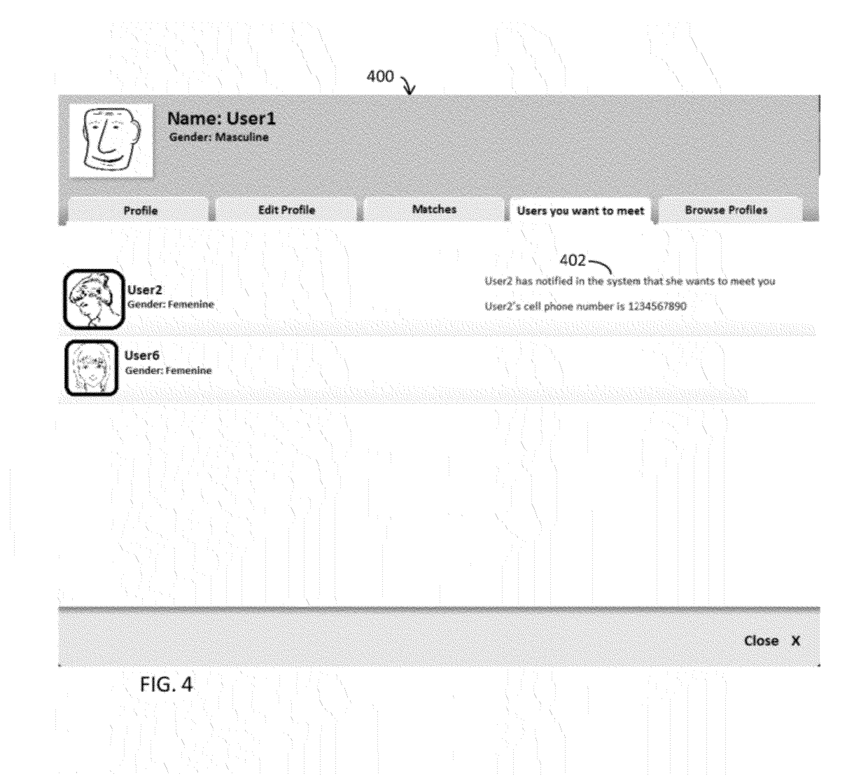

User1 can browse 508 the profiles of other users that have already registered on the system and will be presented FIG. 3 on each of these profiles a button 302 that User1 can click on if he/she wants 510 to meet the person of a particular profile. If User1 doesn't find 510 the profile of another user that he/she wants to meet, User1 can wait 512 to browse again later when there are more user profiles on the system. If User1 finds the profile of User2 (a particular user that User1 wants' to meet), User1 has to click on the button 302 that appears in front of User2's profile (User1 can 522 do the same choosing process with as many other users he/she wants), then the System will store 514 this choice on a database so the data can be used later as explained in subsequent steps of the embodiment of the system and method being described herein. After finding and choosing a user that User1 wants to meet (User2), the choice of User1 wanting to meet User2 will be stored and will not be revealed to anyone at this point, not even to User2. After storing this decision of User1 wanting to meet User2 the system will run an algorithm 516 to find out if there is a decision, from User2 wanting to meet User1, stored in the system database, then, depending on the data found on the database by the algorithm, one of the following two options will occur:
1. The system finds there is a decision from User2 wanting to meet User 1, stored 518 in the system database, so it found a reciprocal decision of User1 and User2 wanting to meet each other, in other words User1 wants to meet User2, and User2 wants to meet User1 as well. Up to this point both decisions were stored in the system and kept confidential (hidden), but when the system finds a match between User1 and User2 wanting to meet each other it will notify both users about it by different means. In the present embodiment of the system and method being disclosed herein, the system will do as described in both steps a) and b) below:
   a) The system will send an SMS (Short Message Service) message to the cell phone of User1 letting him/her know that there is a reciprocal decision between him/her and User2 wanting to meet each other, and will also send an SMS (Short Message Service) message to the cell phone of User2 letting him/her know that there is a reciprocal decision between him/her and User1 wanting to meet each other. The SMS (Short Message Service) message is sent with the contact information of the users so they can get in contact immediately if they wish, so User1 will receive an SMS (Short Message Service) message including data that User2 entered on his/her profile in the system, that is User2's name, cell phone number and gender (if User2 entered his/her name and gender as for the present embodiment they are optional). User2 will receive an SMS message including data that User1 entered on his/her profile in the system, that is User1's name, cell phone number and gender (if User1 entered his/her name and gender as for the present embodiment they are optional).
      It would be readily understood by those skilled in the art that also a picture and any other type of data stored on the system memory could be sent to users when using other notification methods different to SMS (Short Message Service).
   b) Also the system will present to User1, on the client 204, an option to see a list FIG. 4 with profile information of all the users that User1 wants to meet (and has notified so in the system by clicking on the “I want to meet this person” button 302). Along with the profile information of each user that User 1 wants to meet, there is a field 402 specifying if there is a reciprocal decision of any particular user also wanting to meet User1, in that case User1 will have access to that particular user cell phone number on the client 204 along with his/her picture, name, and gender. It will be obvious to someone skilled in the art that many other fields could be used on the users' profiles, and system notifications can be sent by many other means to different types of devices.

After being notified of the reciprocal decision of User1 and User2 wanting to meet each other 518, they will be able to meet each other immediately in person if they are near, or by using their cell phones as both of them were notified with each other cell phone number.
2. The system finds there is no decision from User2 wanting to meet User1, stored 520 in the system database, so no reciprocal decision of User1 and User2 wanting to meet each other is found, in other words User1 wants to meet User2 but User2 does not want to meet User1, or at least hasn't notified so in the system by clicking on the “I want to meet this person” button 302 at User1's profile. So User1 's decision will remain confidential (hidden) and nobody will know about it ever, unless User2 decides to meet User1 and notifies so in the system by clicking on the “I want to meet this person” button 302 at User1's profile, in which case the process 518 of option 1 above will follow.

### DETAILED DESCRIPTION

### SECOND EMBODIMENT

Referring first to FIG. 2, the basic components of the present embodiment of the invention are a server 202, a client 204 a user 210, and a network 208. The server 202 may refer broadly to any computer programmed and configured so the system and method works as described herein. A user 210 may refer broadly to anyone who uses the system and method described herein. A client 204 may refer broadly to any hardware or software that interacts with users 210 and servers 202 so the system and method works as described herein. Network 208 may refer broadly to any means of communication that could be used for data transfer between clients 204 and servers 202. The server interacts or communicates with the clients using a network 208. The embodiment of the system described herein works with at least one client 204, one server 202 and two users 210, but it will be readily understood for those skilled in the art, that the number of servers 202, clients 204, and users 210 can increase without altering the normal operation or the essence of the invention disclosed herein. It also will be readily understood by those skilled in the art, that a client 204 can be a computer (which could be anywhere) capable of interacting with users 210 and servers 202, an application installed on any device capable of interacting with users 210 and servers 202, a web browser capable of interacting with users 210 and servers 202, or any other hardware or software capable of interacting with users 210 and servers 202. Users 210 interact with the system through a client 204.

### Operation

### SECOND EMBODIMENT

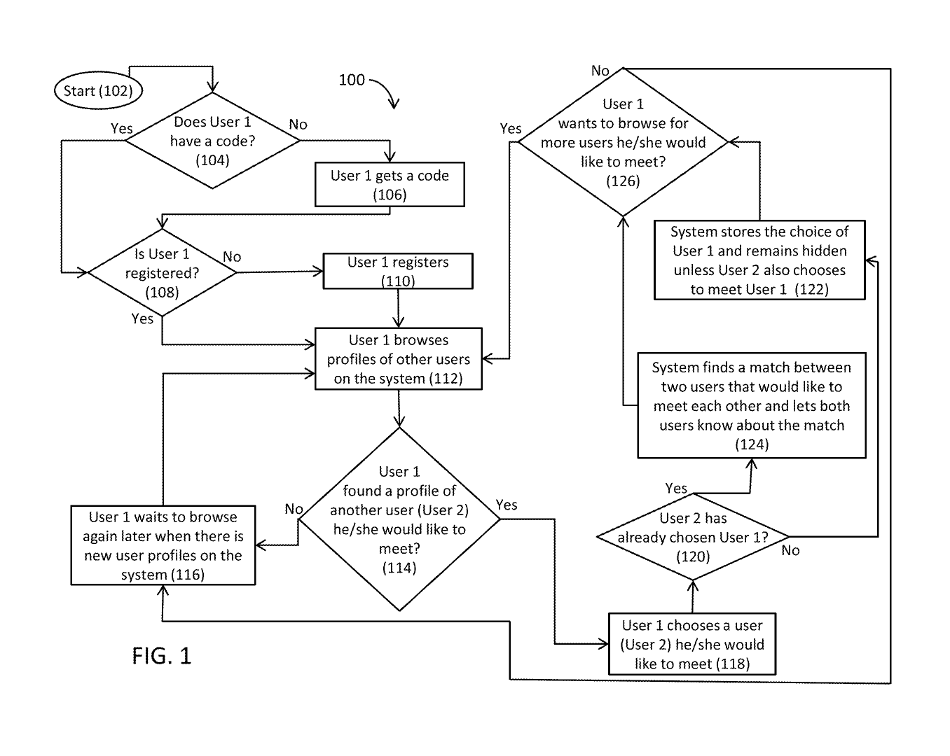

FIG. 1 is a high level block diagram describing one embodiment of the system and method disclosed herein. For explanation purposes the invention will be described as it is embodied in a system that facilitates humans (users) to meet other humans (users). It will be readily understood by those skilled in the art that the system and method disclosed herein is not so limited, as it can be used for many other different purposes, and can be made using many other different devices, software, networks, hardware, or means of communication.

FIG. 1 shows an embodiment in which a user 210 interacts with the system and method embodied herein (also referred to below as “the system”) for the first time, so it goes through all the steps from the start 102. If the user doesn't have 104 a code, he/she won't have access to the system, as the client 204 will ask for a code from the beginning, so the user 210 has to buy 106 a code by paying a predefined amount in order to have access to the system using a client 204. the code can be obtained online by paying a predefined amount with credit card or any other online payment method, it can also be obtained at a bar, a restaurant, or any other public or non public place where the system is installed (a client 204 is present) or at least where codes for using the system and method embodied herein are offered for sale, then the user can pay for the code by credit card, debit card, cash, check or any other payment method allowed on the public or non public place the user wants to get the code. Once User1 (a particular user) has 106 a code, he/she can access the system by entering the code on the initial screen appearing on the client 204 that User1 is accessing. The system checks the code according to predefined rules in order to validate if it's genuine and whether it was previously used by another user, after this, if no problems with the code are found, User1 will have access to the system (otherwise User1 will not have access using that code). If User1 hasn't registered 108 yet on the system he/she will be presented a screen where he/she can enter 110 his/her basic contact information in order to create a user profile, so User1 can be found later by other users in the system and can also be contacted when the system finds a match between User1 and other user, as explained in subsequent steps of the present embodiment. An e-mail, password, cell phone number and picture of the user are the only required fields for a user who wants to create a profile on the system. In order to upload his/her picture, a user can use a camera that is on the client he/she is using, or can use a picture from a website by saving the picture's link on the system. There are also 2 more fields that appear to the user on the profile creation screen which are not required, those are the name of the user and the gender of the user. After User1 enters the data in at least the required fields on the system, the data will be stored on the system database so it can be used later as explained in subsequent steps of the embodiment of the system and method being described herein.

Once User1 has entered and saved 110 his/her profile on the system, other users will be able to see User1's profile including only User1's picture, name and gender (if User1 decided to include his/her name and gender as for this embodiment of the system and method they are optional). The cell phone number of User1 (or any other user) will not be displayed on the system yet; it will be displayed or sent only when there is a match between 2 users as explained in subsequent steps of the embodiment of the system and method being described herein. User1 makes a decision about who he/she would like to meet, this decision is personal and may have been made just by seeing someone at a public or non public place, online or offline, by seeing his/her profile information on the system embodied herein, or by any other reason User1 may want to meet another user of the system embodied herein.

User1 can browse 112 the profiles of other users that have already registered on the system and will be presented FIG. 3 on each of these profiles a button 302 that User1 can click on, if he/she wants 114 to meet the person of a particular profile. If User1 doesn't find 114 the profile of another user that he/she wants to meet, User1 can wait 116 to browse again later when there are more user profiles on the system. If User1 finds the profile of User2 (a particular user that User1 wants' to meet), User1 has to click on the button 302 that appears in front of User2's profile (User1 can 126 do the same choosing process with as many other users he/she wants), then the System will store 118 this choice on a database so the data can be used later as explained in subsequent steps of the embodiment of the system and method being described herein. After finding and choosing a user that User1 wants to meet (User2), the choice of User1 wanting to meet User2 will be stored and will not be revealed to anyone at this point, not even to User2. After storing this decision of User1 wanting to meet User2 the system will run an algorithm 120 to find out if there is a decision, from User2 wanting to meet User1, stored in the system database, then, depending on the data found on the database by the algorithm, one of the following two options will occur:
1. The system finds there is a decision from User2 wanting to meet User1, stored 124 in the system database, so it found a reciprocal decision of User1 and User2 wanting to meet each other, in other words User1 wants to meet User2, and User2 wants to meet User1 as well. Up to this point both decisions were stored in the system and kept confidential (hidden), but when the system finds a match between User1 and User2 wanting to meet each other it will notify both users about it by different means. In the present embodiment of the system and method being disclosed herein, the system will do as described in both steps a) and b) below:
   a) The system will send an SMS (Short Message Service) message to the cell phone of User1 letting him/her know that there is a reciprocal decision between him/her and User2 wanting to meet each other, and will also send an SMS (Short Message Service) message to the cell phone of User2 letting him/her know that there is a reciprocal decision between him/her and User1 wanting to meet each other. The SMS (Short Message Service) message is sent with the contact information of the users so they can get in contact immediately if they wish, so User1 will receive an SMS (Short Message Service) message including data that User2 entered on his/her profile in the system, that is User2's name, cell phone number and gender (if User2 entered his/her name and gender as for the present embodiment they are optional). User2 will receive an SMS message including data that User1 entered on his/her profile in the system, that is User1's name, cell phone number and gender (if User1 entered his/her name and gender as for the present embodiment they are optional).
      It would be readily understood by those skilled in the art that also a picture and any other type of data stored on the system memory could be sent to users when using other notification methods different to SMS (Short Message Service).
   b) Also the system will present to User1, on the client 204, an option to see a list FIG. 4 with profile information of all the users that User1 wants to meet (and has notified so in the system by clicking on the “I want to meet this person” button 302). Along with the profile information of each user that User 1 wants to meet, there is a field 402 specifying if there is a reciprocal decision of any particular user also wanting to meet User1, in that case User1 will have access to that particular user cell phone number on the client 204 along with his/her picture, name, and gender. It will be obvious to someone skilled in the art that many other fields could be used on the users' profiles, and system notifications can be sent by many other means to different types of devices.

After being notified of the reciprocal decision of User1 and User2 wanting to meet each other 124, they will be able to meet each other immediately in person if they are near, or by using their cell phones as both of them were notified with each other cell phone number.
2. The system finds there is no decision from User2 wanting to meet User1, stored 122 in the system database, so no reciprocal decision of User1 and User2 wanting to meet each other is found, in other words User1 wants to meet User2 but User2 does not want to meet User1, or at least hasn't notified so in the system by clicking on the “I want to meet this person” button 302 in front of User1's profile. So User1's decision will remain confidential (hidden) and nobody will know about it ever, unless User2 decides to meet User1 and notifies so in the system by clicking on the “I want to meet this person” button 302 in front of User1's profile, in which case the process 124 of option 1 above will follow.

### DETAILED DESCRIPTION

### THIRD EMBODIMENT

Referring first to FIG. 2, the basic components of the present embodiment of the invention are a server 202, a client 204 a user 210, and a network 208. The server 202 may refer broadly to any computer programmed and configured so the system and method works as described herein. A user 210 may refer broadly to anyone who uses the system and method described herein. A client 204 may refer broadly to any hardware or software that interacts with users 210 and servers 202 so the system and method works as described herein. Network 208 may refer broadly to any means of communication that could be used for data transfer between clients 204 and servers 202. The server interacts or communicates with the clients using a network 208. The embodiment of the system described herein works with at least one client 204, one server 202 and two users 210, but it will be readily understood for those skilled in the art, that the number of servers 202, clients 204, and users 210 can increase without altering the normal operation or the essence of the invention disclosed herein. It also will be readily understood by those skilled in the art, that a client 204 can be a computer (which could be anywhere) capable of interacting with users 210 and servers 202, an application installed on any device capable of interacting with users 210 and servers 202, a web browser capable of interacting with users 210 and servers 202, or any other hardware or software capable of interacting with users 210 and servers 202. Users 210 interact with the system through a client 204.

### Operation

### THIRD EMBODIMENT

FIG. 1 is a high level block diagram describing one embodiment of the system and method disclosed herein. For explanation purposes, the invention will be described as it is embodied in a system that facilitates humans (users) to meet other humans (users) that are located at the same place or at least nearby, as for the present embodiment, the system is located at a bar, with a client 204 computer located at the men's restroom (or men's room) and another client 204 computer located at the Women's restroom (Women's room). At least two users are located at the same bar (also referred to below as “the bar”) where the system is installed. Users have cell phones that can also be used as clients 204 by downloading an application that lets them access the system, or by using the cell phone's web browser to access the system on a website. It will be readily understood by those skilled in the art that the system and method disclosed herein is not so limited, as it can be used for many other different purposes, and can be made using many other different devices, software, networks, hardware, or means of communication.

FIG. 1 shows an embodiment in which a user 210 interacts with the system and method embodied herein (also referred to below as “the system”) for the first time, so it goes through all the steps from the start 102. If the user doesn't have 104 a code, he/she won't have access to the system, as the client 204 will ask for a code from the beginning, so the user 210 has to buy 106 a code by paying a predefined amount in order to have access to the system using a client 204. The user 210 can obtain the code at the bar where the system is installed and its cost can be added to the check to be paid at the end, along with other products the user asks for. Once User1 (a particular user) has 106 a code, he/she can access the system by entering the code on the initial screen appearing on the client 204 that User1 is accessing. The system checks the code according to predefined rules in order to validate if it's genuine and whether it was previously used by another user, after this, if no problems with the code are found, User1 will have access to the system (otherwise User1 will not have access using that code). User1 can access the system by using the client that is at the men's/women's room, or by using his/her cell phone's web browser, or by using his/her cell phone's client application, as in all cases the system will know User1 is at the bar, either because the user accesses the system using the client 204 located at the bar's men's/women's room, or because the mobile device that User1 uses as a client (his/her cell phone in this embodiment) to access the system, sends its current location data to the system. It would be readily understood by those skilled in the art, that the current location of the client can be determined by a GPS (Global Positioning System), or any other locating method, even the user itself can enter its current location on the system.

If User1 hasn't registered 108 yet on the system he/she will be presented a screen where he/she can enter 110 his/her basic contact information in order to create a user profile, so User1 can be found later by other users in the system and can also be contacted when the system finds a match between User1 and other user, as explained in subsequent steps of the present embodiment. An e-mail, password, cell phone number and a picture of the user are the only required fields for a user who wants to create a profile on the system. In order to upload his/her picture, a user can use a camera that is on the client he/she is using, or can use a picture from a website by saving the picture's link on the system. There are also 2 more fields that appear to the user on the profile creation screen which are not required, those are the name of the user and the gender of the user. After User1 enters the data in at least the required fields on the system, the data will be stored on the system database so it can be used later as explained in subsequent steps of the embodiment of the system and method being described herein.

Once User1 has entered and saved 110 his/her profile on the system, other users will be able to see User1's profile including only User1's picture, name and gender (if User1 decided to include his/her name and gender as for this embodiment of the system and method they are optional). The cell phone number of User1 (or any other user) will not be displayed on the system yet; it will be displayed or sent only when there is a match between 2 users as explained in subsequent steps of the embodiment of the system and method being described herein. User1 makes a decision about who he/she would like to meet, this decision is personal and may have been made just by seeing someone at the bar where the system is installed (or the location that the mobile device is sending to the system), or by any other reason User1 may want to meet another user of the system embodied herein.

User1 can browse 112 the profiles of other users that have already registered on the system and will be presented FIG. 3 on each of these profiles a button 302 that User1 can click on, if he/she wants 114 to meet the person of a particular profile. If User1 doesn't find 114 the profile of another user that he/she wants to meet, User1 can wait 116 to browse again later when there are more user profiles on the system. If User1 finds the profile of User2 (a particular user that User1 wants' to meet), User1 has to click on the button 302 that appears in front of User2's profile (User1 can 126 do the same choosing process with as many other users he/she wants), then the System will store 118 this choice on a database so the data can be used later as explained in subsequent steps of the embodiment of the system and method being described herein. After finding and choosing a user that User1 wants to meet (User2), the choice of User1 wanting to meet User2 will be stored and will not be revealed to anyone at this point, not even to User2. After storing this decision of User1 wanting to meet User2 the system will run an algorithm 120 to find out if there is a decision, from User2 wanting to meet User1, stored in the system database, then, depending on the data found on the database by the algorithm, one of the following two options will occur:
1. The system finds there is a decision from User2 wanting to meet User1, stored 124 in the system database, so it found a reciprocal decision of User1 and User2 wanting to meet each other, in other words User1 wants to meet User2, and User2 wants to meet User1 as well. Up to this point both decisions were stored in the system and kept confidential (hidden), but when the system finds a match between User1 and User2 wanting to meet each other it will notify both users about it by different means. In the present embodiment of the system and method being disclosed herein, the system will do as described in both steps a) and b) below:
   a) The system will send an SMS (Short Message Service) message to the cell phone of User1 letting him/her know that there is a reciprocal decision between him/her and User2 wanting to meet each other, and will also send an SMS (Short Message Service) message to the cell phone of User2 letting him/her know that there is a reciprocal decision between him/her and User1 wanting to meet each other. The SMS (Short Message Service) message is sent with the contact information of the users so they can get in contact immediately if they wish, so User1 will receive an SMS (Short Message Service) message including data that User2 entered on his/her profile in the system, that is User2's name, cell phone number and gender (if User2 entered his/her name and gender as for the present embodiment they are optional).
      User2 will receive an SMS message including data that User1 entered on his/her profile in the system, that is User1's name, cell phone number and gender (if User1 entered his/her name and gender as for the present embodiment they are optional).
      It would be readily understood by those skilled in the art that also a picture and any other type of data stored on the system memory could be sent to users when using other notification methods different to SMS (Short Message Service).
   b) Also the system will present to User1, on the client 204, an option to see a list FIG. 4 with profile information of all the users that User1 wants to meet (and has notified so in the system by clicking on the “I want to meet this person” button 302). Along with the profile information of each user that User 1 wants to meet, there is a field 402 specifying if there is a reciprocal decision of any particular user also wanting to meet User1, in that case User1 will have access to that particular user cell phone number on the client 204 along with his/her picture, name, and gender. It will be obvious to someone skilled in the art that many other fields could be used on the users' profiles, and system notifications can be sent by many other means to different types of devices.

After being notified of the reciprocal decision of User1 and User2 wanting to meet each other 124, they will be able to meet each other immediately in person if they are still in the bar, or by using their cell phones as both of them were notified with each other cell phone number.
2. The system finds there is no decision from User2 wanting to meet User1, stored 122 in the system database, so no reciprocal decision of User1 and User2 wanting to meet each other is found, in other words User1 wants to meet User2 but User2 does not want to meet User1, or at least hasn't notified so in the system by clicking on the “I want to meet this person” button 302 in front of User1's profile. So User1's decision will remain confidential (hidden) and nobody will know about it ever, unless User2 decides to meet User1 and notifies so in the system by clicking on the “I want to meet this person” button 302 in front of User1's profile, in which case the process 124 of option 1 above will follow.

### CONCLUSION, RAMIFICATIONS AND SCOPE

A successful implementation of the system and method described herein will change a paradigm in which meeting people is complicated, expensive, uncomfortable, and/or takes a lots of time, and will enable people to use the advantages of technology to meet other people without being limited to interact through a computer or a cell phone screen, but interacting in person after just seconds or minutes of finding a match.

Accordingly the reader will see that the embodiments provided for the invention in the above description contain many specificities, these should not be construed as limitations on the scope of any embodiment, but as exemplifications of the presently preferred embodiments thereof. Many other ramifications and variations are possible within the teachings of the various embodiments. For example on some embodiments a user may be required to buy a code in order to create a profile in the system, on other embodiments a code is not required. Also the number of required and non-required details presented to a user when he/she is creating a profile in the system may increase or decrease.

The system and method can be used with any purpose, e.g., to date someone, to meet a person with the intention of doing business, to make friends, to match businesses interested on a particular topic, etc . . . Users can create a profile on the system by entering the data themselves or by using the data they already entered on a different online service like a social network (e.g. Facebook, Twitter, etc). The technology used in order to make the system and method work may change as new devices and platforms are developed. Thus the scope of the invention should be determined by the appended claims and their legal equivalents, and not by the examples given.

1. A method of providing matching between humans, comprising:
providing at least two users (User1 and User2),
providing a means for said users to choose other users they would like to meet and keeping those choices confidential,
providing a means for finding matches of users who would like to meet each other,
notifying said users for which a match is found.

2. The means for said users to choose other users they would like to meet of claim 1 further including at least one client.

3. The means for said users to choose other users they would like to meet of claim 1 further including at least one server.

4. The means for said users to choose other users they would like to meet of claim 1 further including a means for interacting between each of said servers with each of said clients.

5. The means for said users to choose other users they would like to meet of claim 1 further including a means for determining each of said client's current location.

6. The means for said users to choose other users they would like to meet of claim 1 further including a form where said users create a profile with at least a means for contacting.

7. The means for said users to choose other users they would like to meet of claim 1 further including a means for storing said users' profile and said users' current location on a means for storing data.

8. The notifying said users for which a match is found of claim 1 wherein said notification includes said other user's means for contacting.

9. A user matching system comprising:
at least two users of the system (User1 and User2),
a means for said users to choose other users they would like to meet and keeping those choices confidential,
a means for finding matches of users who would like to meet each other,
a means for notifying said users for which a match is found.

10. The means for said users to choose other users they would like to meet of claim 9 further including at least one client.

11. The means for said users to choose other users they would like to meet of claim 9 further including at least one server.

12. The means for said users to choose other users they would like to meet of claim 9 further including a means for interacting between each of said servers with each of said clients.

13. The means for said users to choose other users they would like to meet of claim 9 further including a means for determining each of said client's current location.

14. The means for said users to choose other users they would like to meet of claim 9 further including a form where said users create a profile with at least a means for contacting.

15. The means for said users to choose other users they would like to meet of claim 9 further including a means for storing said users' profile and said users' current location on a means for storing data.

16. The notifying said users for which a match is found of claim 9 wherein said notification includes said other user's means for contacting.
